(19) United States
(12) Patent Application Publication
(10) Pub. No.: US 2023/0146425 A1
(43) Pub. Date: May 11, 2023

(54) MATERIAL DEPOSITION UNIT FOR POWDER BUILD-UP WELDING

(71) Applicant: TRUMPF Laser- und Systemtechnik GmbH, Ditzingen (DE)

(72) Inventors: Robert Ganter, Gerlingen (DE); Tim Hesse, Ditzingen (DE); Kevin Kruse, Freiberg (DE); Gerhard Link, Knittlingen (DE); Steven Mueller, Freiberg am Neckar (DE); Marco Opitz, Waldstetten (DE); Bjoern Sautter, Stuttgart (DE); Fabian Goetzelmann, Stuttgart (DE); Nicolai Speker, Pleidelsheim (DE); Franziska Horer, Holzgerlingen (DE); Anh-Thu Tran, Schwieberdingen (DE); Benedikt Wessinger, Kaempfelbach (DE)

(21) Appl. No.: 17/879,830

(22) Filed: Aug. 3, 2022

Related U.S. Application Data
(63) Continuation of application No. PCT/EP2021/052570, filed on Feb. 3, 2021.

(30) Foreign Application Priority Data
Feb. 7, 2020 (DE) 10 2020 103 175.0

(51) Int. Cl. B22F 12/50; B23K 26/342; B23K 26/14; B22F 12/40; B33Y 30/00

(52) U.S. Cl. CPC B22F 12/50; B22F 12/40; B23K 26/342; B23K 26/1464; B33Y 30/00

(57) ABSTRACT

A material deposition unit includes a radiation unit designed to emit electromagnetic radiation in a directed manner onto a workpiece along a beam axis, and a powder discharge device that has multiple powder discharge units configured to discharge powder in a directed form onto the workpiece through powder-outlet openings. The material deposition unit further includes a powder division unit having multiple powder channels. A number of powder channels corresponds to a number of powder discharge units. The powder division unit is designed to distribute a central powder stream guided to a feed channel uniformly over the powder channels. Each respective powder channel is connected to a respective powder discharge unit by an exchangeable connecting element. At least one powder discharge unit has an exchangeable powder discharge element, which is elongate, has a first end and a second end, and is arranged at least partially within the corresponding powder discharge unit.

### CROSS REFERENCE TO RELATED APPLICATIONS

This application is a continuation of International Application No. PCT/EP2021/052570 (WO 2021/156317 A1), filed on Feb. 3, 2021, and claims benefit to German Patent Application No. DE 10 2020 103 175.0, filed on Feb. 7, 2020. The aforementioned applications are hereby incorporated by reference herein.

### FIELD

Embodiments of the invention relate to a material deposition unit.

### BACKGROUND

Laser build-up welding (also Laser Metal Deposition (LMD), Direct Metal Deposition (DMD) or Direct Energy Deposition (DED)) is a generative manufacturing method for metallic structures.

In principle, laser build-up welding is carried out as follows: On a component surface, by means of a laser a melt pool is created or a base material forming the component surface is heated. When reference is made to “melt pool” below, what is also meant by this is a general process zone which comprises a heated or molten base material. The melt pool can for example melt a few micrometers of the base material, but greater melting depths are also conventional. Metal powder is introduced in an automated manner by means of a powder discharge device, usually in the form of a nozzle. The result is beads or material layers which are welded to one another and produce structures on existing or new basic bodies or components.

(Laser) build-up welding makes it possible for example to apply 3D structures to existing or new, possibly also uneven, surfaces. Geometry modifications can be easily implemented in this way. By modifying the powder and/or the powder composition, it is possible to switch between various materials in one work process. It is also possible to blend the powder used from different materials and thereby to create alloys. To provide wear-resistant layers, it is for example possible to feed a matrix material in powder form which melts in the melt pool and in addition to feed a hard material, which typically does not melt at the temperatures prevailing in the melt pool, likewise in powder form.

What is referred to as extreme high-speed laser build-up welding (EHLA) is already known from DE 10 2011 100 456 B4. According to this method, a significant increase in the achievable machining speed compared to conventional laser build-up welding is obtained in that at least one completely molten filler material is fed to a melt pool present on a surface to be machined. For this purpose, the filler material, which initially is present in particular as a powder, is melted by means of a laser beam at a distance from the melt pool of greater than zero and then fed to the melt pool in completely liquid form. In this respect, the same laser beam can melt the filler material, in particular the powder, at the stated distance from the melt pool and heat the melt pool. The laser beam incident on the melt pool thus also causes the filler material to melt at the stated distance from the melt pool. This is performed by moving the melt pool and a focus of the laser beam parallel to one another relative to the surface at a speed of at least 20 m/min. Furthermore, in the case of a powdered filler material, the powder density can be set in particular such that a laser power output of the laser beam in the melt pool is less than 60% of the laser power output before the laser beam makes contact with the powder.

During laser build-up welding, it is conventional to use a material deposition unit having a laser unit which is configured to direct a laser beam onto a workpiece, and having a powder discharge device which is configured to discharge powder in a directed form onto the workpiece.

In this context, the powder discharge device is conventionally designed in such a way that it discharges the material powder in the direction of the workpiece via an annular die or multiple powder discharge units, as disclosed e.g. in US 5961862 A, which may be in the form of powder-outlet openings, for example. This results in one powder jet or a plurality of powder jets. These powder jets are focused in a material focal zone. In this context, the existing systems are sensitive to the distance of the powder discharge device and the powder focal position from the workpiece and to the combination of angle of contact (angle at which the laser beam is directed on the workpiece), distance and diameter of the material focus.

Moreover, the distribution of the powder over the individual powder discharge units constitutes a problem. The powder mass stream that is fed should be divided as uniformly as possible over the individual powder discharge units, it being the intention to keep the installation space needed for the powder discharge device as small as possible.

### SUMMARY

Embodiments of the present invention provide a material deposition unit that includes a radiation unit designed to emit electromagnetic radiation in a directed manner onto a workpiece along a beam axis extending in a beam direction. The material deposition unit further includes a powder discharge device that has multiple powder discharge units configured to discharge powder in a directed form onto the workpiece through powder-outlet openings. The material deposition unit further includes a powder division unit having multiple powder channels. A number of powder channels corresponds to a number of powder discharge units. The powder division unit is designed to distribute a central powder stream guided to a feed channel uniformly over the powder channels. Each respective powder channel is connected to a respective powder discharge unit by an exchangeable connecting element. At least one powder discharge unit has an exchangeable powder discharge element. The powder discharge element is elongate, has a first end and a second end, and is arranged at least partially within the corresponding powder discharge unit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a side view of a powder discharge device of a material deposition unit according to embodiments of the invention;

FIG. 2 shows a cross section, from the side, of the powder discharge device according to FIG. 1;

FIG. 3 shows a perspective view of the powder discharge device according to FIG. 1;

FIG. 4 shows a cross section, from the side, of a first functional zone of the powder division unit according to embodiment of the present invention;

FIG. 5 shows a cross section, from the side, of a second functional zone of the powder division unit according to embodiment of the present invention;

FIG. 6 shows a plan view of a separating part of the powder division unit according to embodiment of the present invention;

FIG. 7 shows a cross section, from the side, of a separating part according to FIG. 6;

FIG. 8 shows a perspective view of a separating part according to FIG. 6 according to embodiment of the present invention;

FIG. 9 shows a cross section, from the side, of a separating part according to FIG. 6 in a state connected to a second functional zone according to FIG. 5 according to embodiment of the present invention;

FIG. 10 shows a cross section, from the side, of a powder discharge device according to FIG. 1 in a state connected to a separating part according to FIG. 6;

_FIG. 11 shows a cross section, from the side, according to FIG. 10 with a powder discharge element according to embodiment of the present invention; and

FIG. 12 shows a cross section, from the side, according to FIG. 10 with a further exemplary embodiment of a powder discharge element according to embodiment of the present invention.

### DETAILED DESCRIPTION

The material deposition unit according to embodiments of the invention comprises: A radiation unit designed to emit electromagnetic radiation in a directed manner, in particular a laser unit, a powder discharge device and a powder division unit.

The radiation unit, in particular laser unit, is configured to direct electromagnetic radiation, in particular a laser beam, onto a workpiece along a beam axis extending in a beam direction, and in particular to focus it there (it may also be provided that defocusing is effected at the workpiece). On the workpiece, the radiation, in particular the laser beam impinging there, in particular focused there, creates a weld pool or a melt pool.

The powder discharge device is configured to discharge a material powder, which typically is or comprises a metallic or ceramic powder, onto the workpiece. Typically, this is realized by a powder/gas jet. In this respect, the powder discharge device comprises multiple, in particular at least seven, in particular exactly seven, powder discharge units, which are configured to discharge the powder through powder-outlet openings in directed form (for example in the form of a jet or multiple jets) onto the workpiece.

Typically, the material deposition unit is designed in such a way that the powder discharge units (in particular in the form of channels to be directed toward one another) are uniformly distributed circumferentially around the beam axis. This results in particular in a preferred uniform build-up behavior of the material deposition unit.

The powder division unit comprises multiple powder channels. In this context, the number of powder channels corresponds to the number of powder discharge units. In this way, for example, when there are seven powder discharge units, seven powder channels are provided. The powder division unit distributes a central powder stream uniformly over the individual powder channels. The powder division unit is typically rotationally symmetrical or has a rotationally symmetrical cross section.

The powder channels are each connected to the individual powder discharge units by means of an exchangeable connecting element. Thus, for example, when there are seven powder channels or powder discharge units, seven connecting elements are likewise provided. The connecting elements are preferably in the form of flexible hoses.

At least one powder discharge unit has an exchangeable powder discharge element. It is preferably the case that all powder discharge units have a respective powder discharge element. Such a powder discharge element is preferably a small tube. The powder discharge element is elongate and has a first end and a second end. The powder discharge element is arranged at least partially within the corresponding powder discharge unit.

The material of the powder discharge element is preferably a material that reflects near infrared radiation, in particular with a high coefficient of heat conduction. The material is preferably a hard metal alloy, e.g. copper alloy. It is consequently possible to reduce wear and lengthen the service life (time in use). Moreover, this makes it possible to not have to additionally package the powder discharge element.

The connecting elements allow the powder division unit to be decoupled from the powder discharge unit, therefore making pivoting or tilting possible, for example. Moreover, dividing the central powder stream into multiple, in particular seven, discrete individual powder jets achieves a sufficiently high flow velocity along the powder conveying section, in particular within the powder channels, the connecting elements, the powder discharge units and powder discharge elements, with the result that the individual powder/gas jets are not influenced or are scarcely influenced by gravitational force or other acting forces. This increases the flexibility and the areas of use of the material deposition unit.

At least one powder discharge unit may be configured in such a way that a powder discharge element arranged at least partially in this powder discharge unit can be exchanged for another powder discharge element. In this respect, the two exchanged powder discharge elements can have the same outside diameter. This is due to the fact that the two powder discharge elements have to fit at least partially into the same powder discharge unit. However, the two powder discharge elements can have a different inside diameter and/or different lengths.

The second end of at least one powder discharge element may be arranged in the region of the powder-outlet opening of the corresponding powder discharge unit. In particular, it may be arranged flush with the powder-outlet opening, that is to say terminate flush with the powder-outlet opening. In other words, the second end of a powder discharge element may lead into the powder-outlet opening.

However, the second end of at least one powder discharge element may also be arranged outside the corresponding powder discharge unit. This makes the handling involved in exchanging the individual powder discharge elements easier. It is possible to grip the second end of the powder discharge element, for example using tongs, and pull it out of the powder discharge unit.

Advantageously, at least one connecting element may be detachably fixed by means of plug-in connections to a powder discharge unit and/or to a powder channel. The plug-in connections make it possible to easily exchange a connecting element without using a tool. This results in a reduction of possible downtimes (time in which a machine is not working), for example caused by maintenance and/or cleaning. Other types of connections are likewise conceivable, such as e.g. screw connections, bayonet connection, snap connection, etc.

Advantageously, at least one connecting element is at least partially rigid, flexible, straight and/or has at least one curvature. A connecting element may thus be configured as a metallic, rigid tube connection. This may be straight or have at least one bend. A connecting element may also be a flexible plastic hose or a metallic flex hose. Other materials and forms may also be used. This makes it possible to arrange the connecting elements flexibly, with the result that the degree of movement between the powder discharge device and the powder division unit can be increased. This results in greater flexibility of the material deposition unit.

Advantageously, the powder division unit has a longitudinal axis and comprises:
a first functional zone, which is elongate and has a first end, a second end and a round inside diameter, and
a second functional zone, which is elongate and has a first end, a second end and a round inside diameter.

In this respect, the second end of the first functional zone leads in line into the first end of the second functional zone.

The longitudinal axis of the powder division unit may be different from the beam axis or coincide with the beam axis.

Advantageously, the inside diameter of the first functional zone is constant at least in certain portions, in particular at least in a portion through to the second end. The inside diameter of the first functional zone is preferably constant over the entire length of the first functional zone. The inside diameter of the first functional zone is selected to be relatively small compared to the length of the first functional zone. Thus, it may for example be 4 mm, the length being 100 mm. An inside diameter that is small compared to the length forces the powder particles into a trajectory running coaxially with the longitudinal axis of the powder division unit. This avoids undesired turbulences of the powder stream.

Advantageously, the second functional zone comprises a first portion and a second portion. In this respect, the second portion has an inside diameter larger than the first portion. In this way, an expansion zone is established in which the coaxially aligned particles are prepared for separation into the individual powder channels, in that they are slowed down and distributed over a larger cross section. In this context, the transition from the first portion to the second portion (and therefore the enlargement of the inside diameter) may have a configuration becoming larger in one stage or multiple stages, conically or in a curve shape.

The first and the second functional zone may be in the form of separate elements. They may both consist of solid, non-flexible material. Thus, for example, the first functional zone may be configured as a metal tube and the second functional zone may be made from acrylic glass. The two functional zones may be connected detachably to one another, e.g. by means of a plug-in or screw connection. In the assembled-together state, the two functional zones are aligned coaxially with one another, so that they have a common longitudinal axis.

Advantageously, the inside diameter of the first functional zone in the region of the second end of the first functional zone and the inside diameter of the second functional zone in the region of the first end of the second functional zone are the same. In other words, the inside diameter of the first functional zone at the second end of the first functional zone is the same as the inside diameter of the first portion of the second functional zone. This means that the powder particles in the first portion of the second functional zone also remain on their trajectory coaxial with the longitudinal axis of the powder division unit, into which trajectory they have been forced in the first functional zone.

Advantageously, the powder division unit has a separating part. The separating part has a top side and a bottom side. The powder channels are arranged in this separating part. They are preferably arranged rotationally symmetrically in relation to the longitudinal axis of the powder division unit.

The separating part is preferably in the form of a separate element and arranged on the second end of the second functional zone. The separating part may also be fixed by way of a detachable connection (see above).

The powder channels preferably each extend from the top side of the separating part to the bottom side of the separating part. They may be straight and run radially outward, with the result that they each span an angle Alpha with the longitudinal axis of the powder division unit. The angle Alpha is preferably smaller than 45°, in particular 40°. The angle Alpha is preferably larger than 5°, in particular 10°, in particular 15°.

Advantageously, an elevated region is arranged on the top side of the separating part, in particular centrally on the top side. In addition, inlet openings of the individual powder channels are arranged on the top side. In this respect, the inlet openings of the powder channels are arranged on the elevated region. The inlet openings may be uniformly arranged circumferentially around the longitudinal axis of the powder division unit. The inlet openings may be uniformly arranged circumferentially around a frustoconical projection on the elevated region.

As already mentioned, a frustoconical projection may be arranged on the elevated region. The lateral surface of the frustoconical projection may be designed to slope toward the nearest inlet opening of the respective powder channel. A pyramidal shape of the projection is likewise conceivable. In this case, the pyramid has as many sides as there are inlet openings. Each side of the pyramid is directed toward an inlet opening and the side face slopes toward the respective inlet opening.

The powder stream is thus uniformly divided at a point on the top side of the separating part over all powder channels present.

Advantageously, at least one powder channel may have at least two different inside diameters in certain portions. The changing inside diameter within a powder channel makes it possible to influence the trajectory and the flow velocity of the powder particles.

Advantageously, at least one powder discharge element may be arranged coaxially with the corresponding powder discharge unit.

The powder discharge device preferably has a bottom edge. In this respect, the distance between the bottom edge and the workpiece may be 12.5 mm or more. In particular, this distance is exactly 12.5 mm. With this small distance from the workpiece, it is possible to ensure a better shielding-gas covering required for laser build-up welding.

Further features, possible applications and advantages of the invention will become apparent from the following description of the exemplary embodiment of the invention, which will be discussed on the basis of the drawing, it being possible for the features to be essential to the invention both individually and in different combinations, without this being explicitly pointed out again.

In the following figures, corresponding components and elements bear the same reference signs. For the sake of better clarity, all reference signs are not reproduced in all of the figures.

The material deposition unit according to embodiments of the invention comprises a radiation unit, not illustrated, which is arranged in a powder discharge device 12. The radiation unit is designed to emit electromagnetic radiation, in particular laser radiation, in a directed manner onto a workpiece along a beam axis 10 extending in a beam direction.

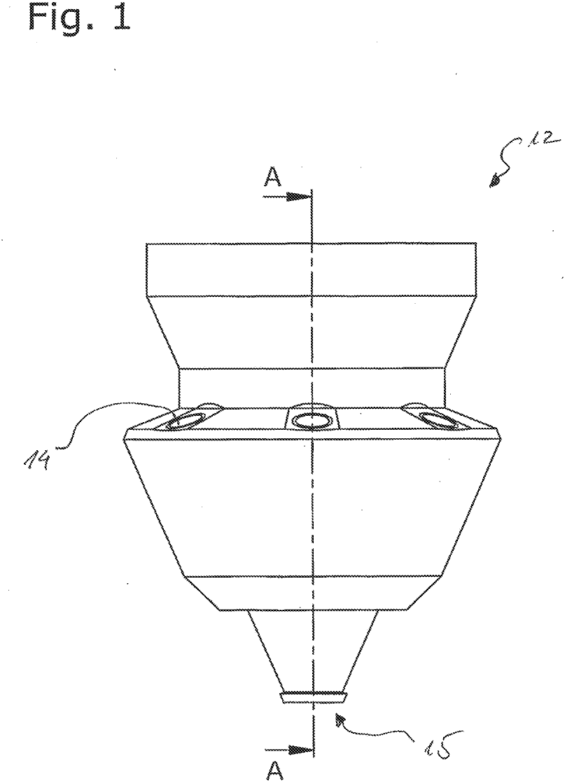

FIG. 1 shows a side view of the powder discharge device 12 of the material deposition unit according to embodiment of the invention. The powder discharge device 12 has multiple powder discharge units 14.

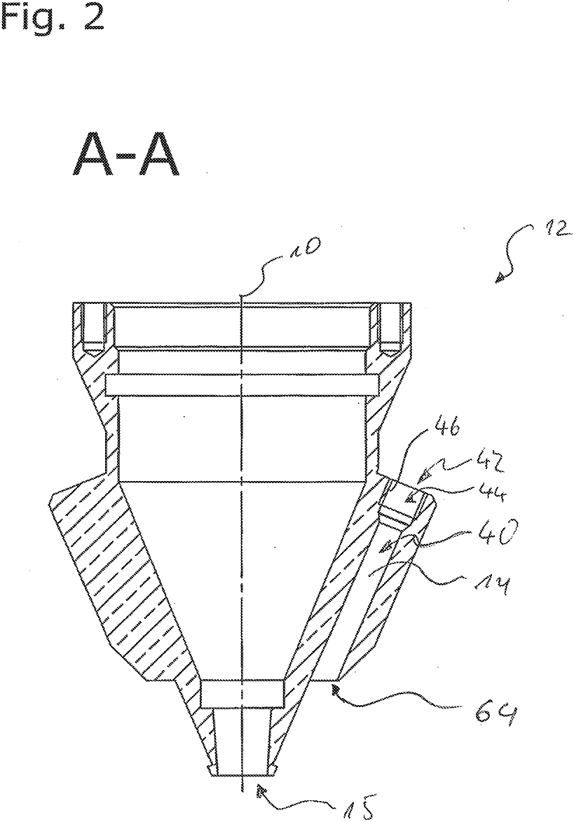

FIG. 2 shows a section through the powder discharge device 12 according to FIG. 1 along the line denoted A-A in FIG. 1. The powder discharge units 14 are in the form of channels 40 in the powder discharge device 12. The channels 40 each have a widened portion 44 on an inlet side 42. Each widened portion 44 bears an internal thread 46.

The powder streams directed by the powder discharge units 14 onto the workpiece to be machined pass through the channels 40 and leave them through powder-outlet openings 64.

The electromagnetic radiation from the radiation unit runs along the beam axis 10 through the powder discharge device 12 and leaves it at an opening 15. The workpiece to be machined is arranged below the opening 15. The radiation unit is configured in such a way that the electromagnetic radiation is focused on the surface of the workpiece to be machined. It may also be focused above the workpiece.

The powder discharge units 14 serve to discharge a powder in the form of respective powder jets in a directed form onto the workpiece. The powder discharge units 14 extend, as illustrated on the right in FIG. 2, in such a way that they are at an angle with respect to the beam axis 10. The powder discharge device 12 is configured in such a way that the powder jets from the powder discharge units 14 intersect at a common focus. This focus may correspond to the focus of the electromagnetic radiation from the radiation unit. However, the focal zones of the electromagnetic radiation and the powder jets may also be spaced apart from one another, in particular along the beam axis 10.

The powder discharge units 14 have a stepped form at their end remote from the common powder focus. In this way, it is possible to be able to arrange a respective connecting element at this end (screwing into the internal thread 46; a plug-in connection is also conceivable). The inside diameter of the connecting element and the inside diameter of the respective powder discharge unit 14 are in particular the same here. A constant inside diameter in the region of the connection between the respective connecting element and the respective powder discharge unit 14 can therefore be realized.

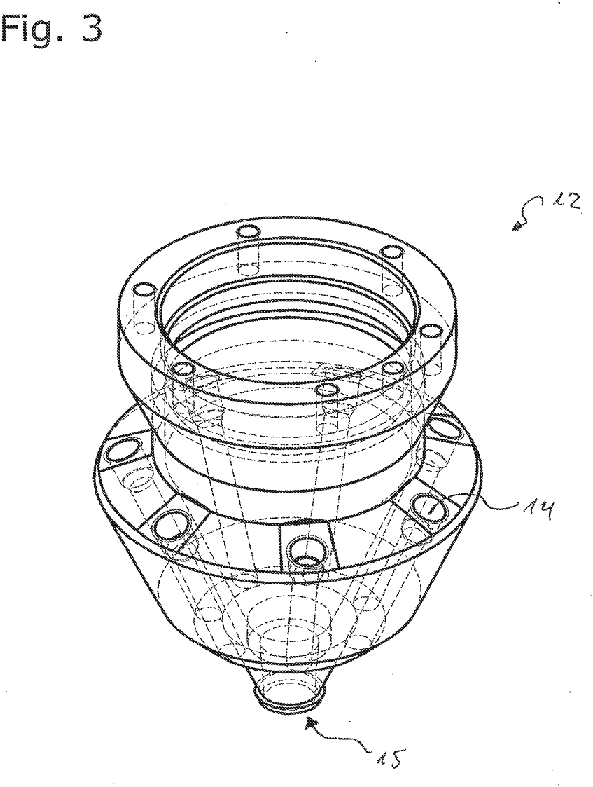

FIG. 3 shows a perspective view of the powder discharge device 12 according to FIG. 1. The powder discharge device 12 shown comprises seven powder discharge units 14. The powder discharge units 14 are uniformly distributed circumferentially around the powder discharge device 12.

The material deposition unit further comprises a powder division unit. In the present case, the powder division unit has two functional zones.

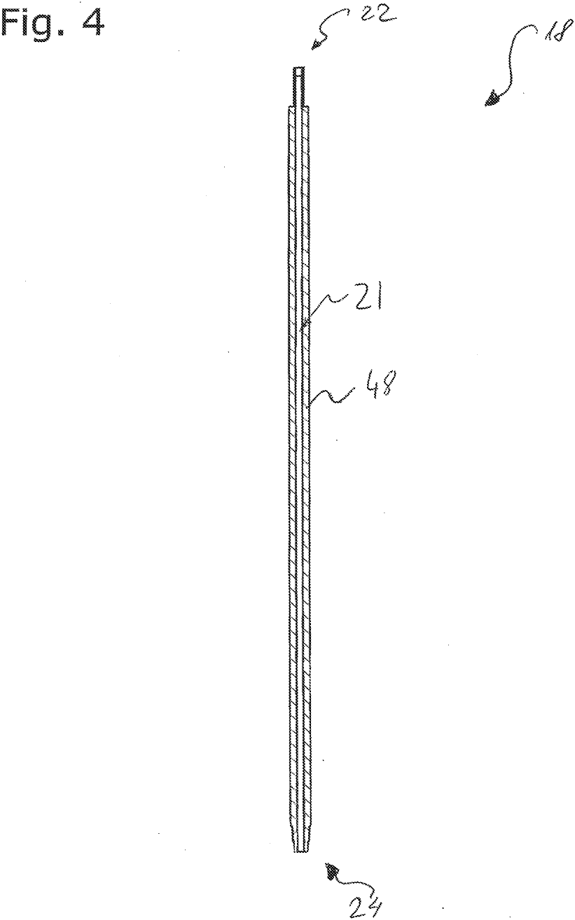

FIG. 4 shows a cross section, from the side, of a first functional zone 18 of the powder division unit. In the present case, the first functional zone 18 is arranged in a first functional element 48. The first functional element 48 is in the form of an elongate metal tube with a constant inside diameter. The first functional zone 18 has a first end 22 and a second end 24. During operation of the material deposition unit, the fed powder stream is conducted from the first end 22 through the first functional zone 18 in the direction of the second end 24. The first functional zone 18 has an inside diameter which is small compared to its length. Consequently, the powder particles within the first functional zone 18 are forced onto a trajectory running axially in relation to the longitudinal extent of the first functional zone 18. Undesired turbulences of the powder stream or of the powder particles can thus be avoided or at least reduced.

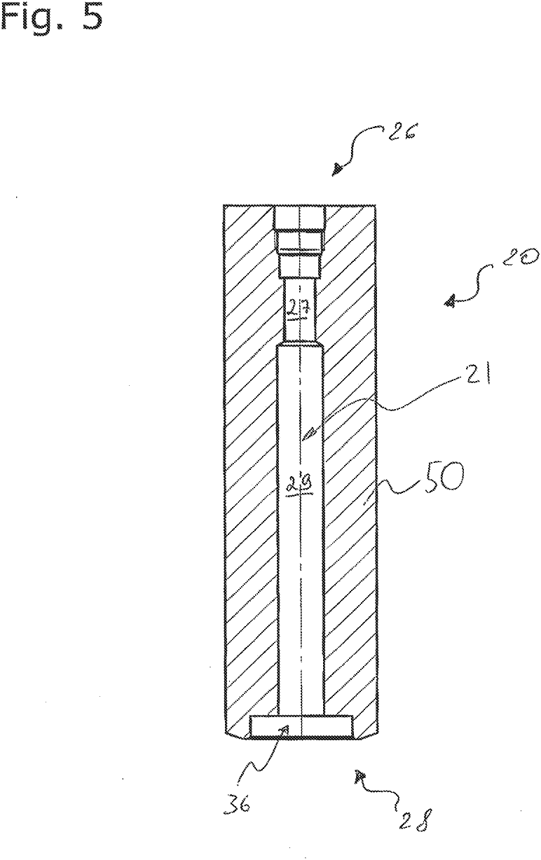

FIG. 5 shows a cross section, from the side, of a second functional zone 20 of the powder division unit. In the present case, the second functional zone 20 is arranged in a second functional element 50. In the present case, the second functional element 50 is configured in the form of an acrylic glass tube. The second functional zone 20 has a first end 26 and a second end 28. In the present case, the first end 26 of the second functional zone 20 is configured such that the second end 24 of the first functional zone 18 can be arranged in line on the first end 26 of the second functional zone 20. For this, the second end 24 of the first functional zone 18 has a stepped form. The first end 26 of the second functional zone 20 has an accordingly corresponding stepped form. The facing ends (second end 24 and first end 26) of the first functional element 48 and the second functional element 50 complement one another. The facing ends of the first functional element 48 and the second functional element 50 can be plugged into one another, with the result that the second end 24 of the first functional element 48 is received in the first end 26 of the second functional element 50.

The first functional zone 18 and the second functional zone 20 are part of a feed channel 21 via which powder particles can be transported by means of a gas stream.

The second functional zone 20 has a first portion 27 and a second portion 29. The inside diameter of the first portion 27 is smaller than the inside diameter of the second portion 29. In the present case, the inside diameter of the first portion 27 is the same as the inside diameter of the first functional zone 18. The first portion 27 of the second functional zone 20 thus constitutes an extension of the first functional zone 18, as it were.

The second portion 29 of the second functional zone 20 establishes an expansion zone. The enlargement of the inside diameter distributes the powder particles over a larger cross-sectional area. This reduces the flow velocity of the powder particles.

The powder division unit also comprises a separating part 30.

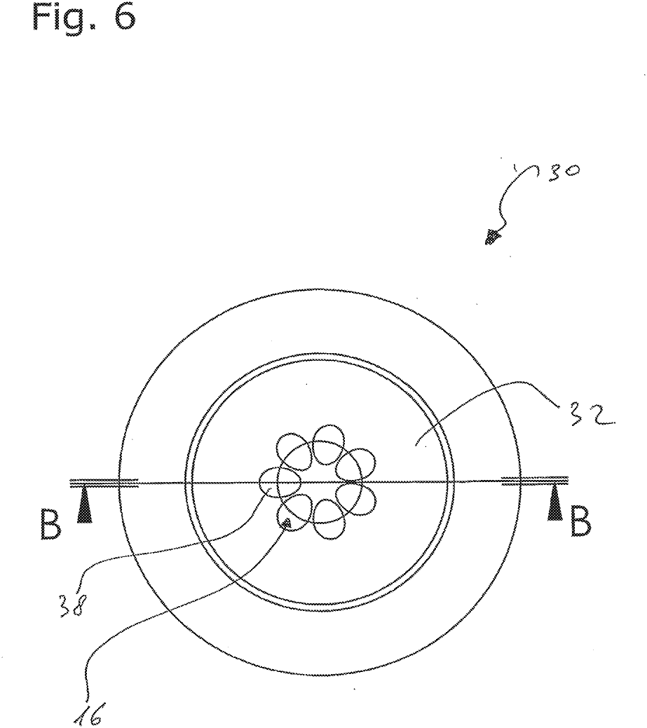

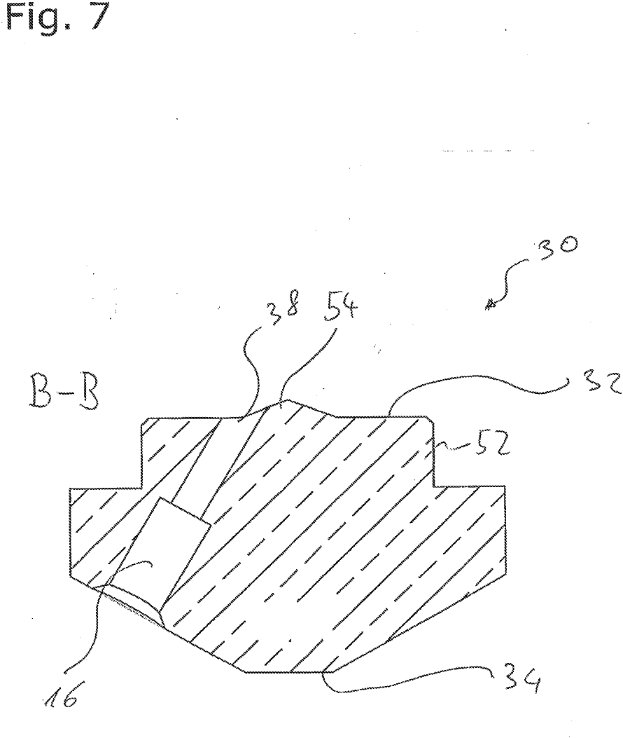

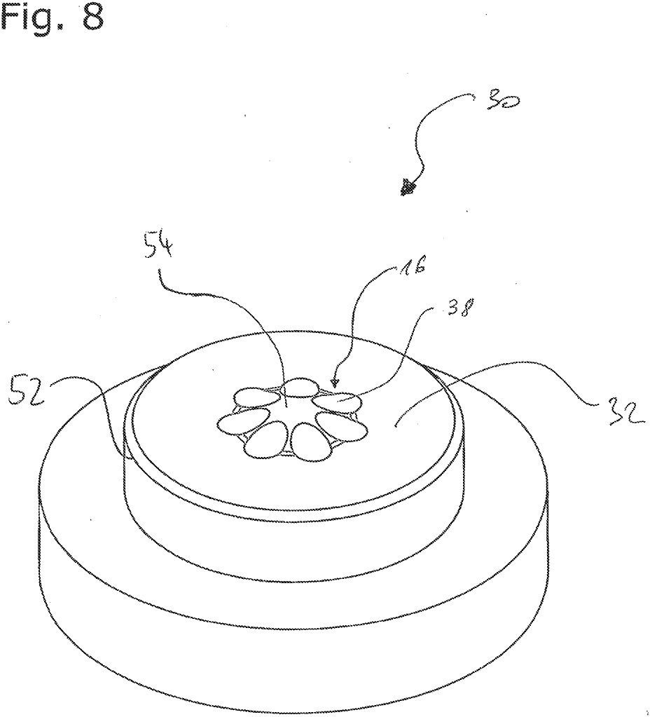

FIG. 6 shows a plan view of the separating part 30 of the powder division unit. The separating part 30 is in the form of a separate element, in the same way as the first functional zone 18 and the second functional zone 20. The separating part 30 has a circular top side 32 and a likewise circular bottom side 34, shown in FIG. 7. Inlet openings 38 of the individual powder channels 16 are arranged on the top side 32. They are uniformly distributed in the circumferential direction.

FIG. 7 shows a section through the separating part 30 according to FIG. 6. Here, the section illustrated in FIG. 7 runs along the line denoted B-B in FIG. 6.

The top side 32 of the separating part 30 has a stepped form. The second end 28 of the second functional zone 20 has a corresponding stepped form. The separating part 30 can be arranged in an accurately fitting manner on the second functional zone 20. During operation, the longitudinal axis of the powder division unit thus runs through the center of the top side 32 of the separating part 30.

The separating part 30 has an elevated region 52, in the center of which a frustoconical projection 54 is arranged. The inlet openings 38 of the powder channels 16 lead into the elevated region 52 and are arranged around the frustoconical projection 54. The lateral surface of the frustoconical projection 54 slopes toward the inlet openings 38 of the powder channels 16.

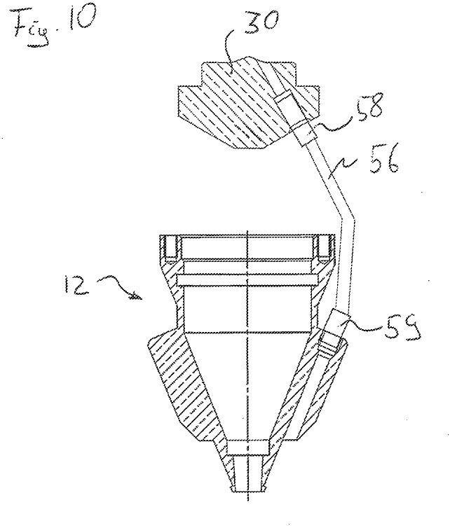

The second portion 29 of the second functional zone 20 leads into a receiving region 36 of the second functional zone 20. The receiving region 36 complements the elevated region 52, with the result that it can be inserted into the receiving region (see FIG. 9).

The powder channels 16 extend, as illustrated on the left in FIG. 7, from the top side 32 of the separating part 30 to the bottom side 34 of the separating part 30. In the present case, the powder channels 16 are straight. The powder channels 16 each have a stepped form at the end opposite the inlet opening 38. In this way, it is possible to be able to arrange a respective connecting element at this end (plug-in connection), the inside diameter of the connecting element and the inside diameter of the respective powder channels 16 being the same. A constant inside diameter in the region of the connection between the respective connecting element and the respective powder channel 16 can therefore be realized.

The inside diameter within a powder channel 16 and within a powder discharge unit 14 interacting therewith and within a connecting element connecting the two to one another may be constant.

As can also be seen in FIG. 7, the powder channels 16 are arranged radially spreading out in the direction of the bottom side 34 of the separating part 30. In other words, each powder channel 16 spans an angle Alpha with the longitudinal axis of the powder division unit. In this exemplary embodiment, this angle Alpha is less than 45°.

During operation of the material deposition unit, the powder mass stream is conducted through the first functional zone 18 and through the second functional zone 20, until it impinges on the top side 32 of the separating part 30. Here, the powder stream is distributed over the individual powder channels 16. The individual powder particles pass through the inlet openings 38 into the individual powder channels 16.

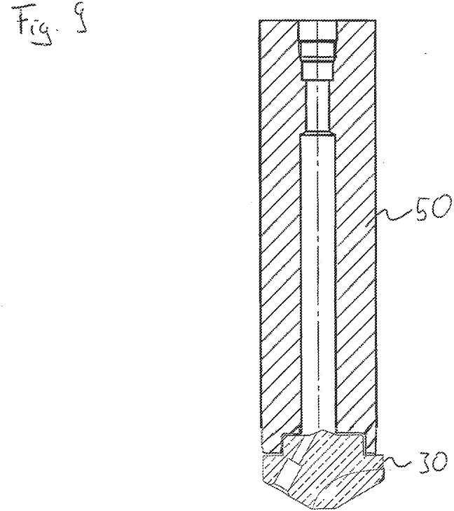

FIG. 8 shows a perspective view of the separating part 30 according to FIG. 6. It can be seen here that the inlet openings 38 are arranged approx. half in the region of the frustoconical projection 54 and approx. half outside the frustoconical projection 54 on the surface 32 of the separating part 30 or of the elevated region 52.

FIG. 9 shows the separating part 30 in a state connected to the second functional element 50.

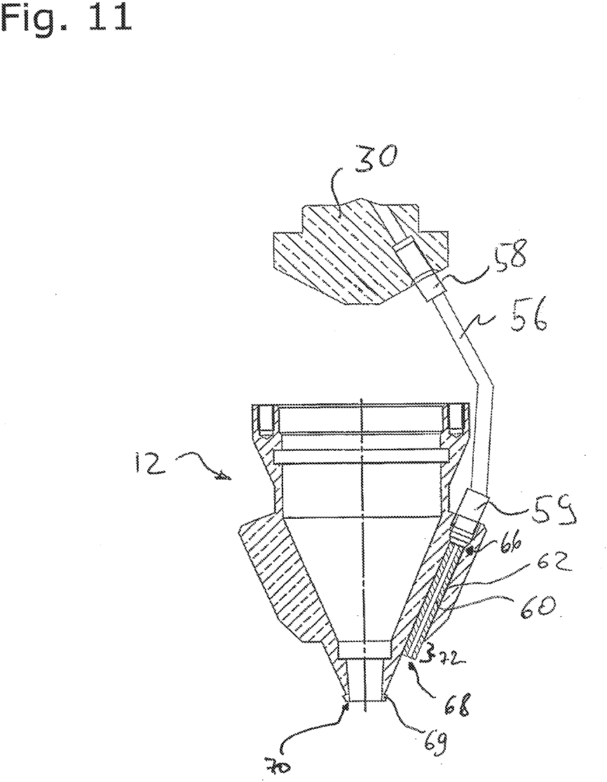

FIG. 10 shows the powder discharge device 12 in a state connected to the separating part 30. The powder discharge device 12 and the separating part 30 are connected by way of one connecting element 56 per powder discharge unit 14 or per powder channel 16. In the present case, only the connecting element 56 located in the sectional plane is shown. The connecting element 56 is plugged in the separating part 30 by means of a first coupling unit and screwed in the powder discharge device 12 by means of a second coupling unit 59. The connecting element 56 may be in the form of a flexurally rigid metallic tube or else a flexible hose connection.

FIG. 11 shows a cross section, from the side, according to FIG. 10 with a powder discharge element 60. In the present case, the powder discharge element 60 is in the form of a small tube 62. The powder discharge element 60 is plugged and pressed into the corresponding powder discharge unit 14. The powder discharge element 60 has a first end 66 and a second end 68. The powder discharge element 60 is aligned in such a way that it is aligned with its second end 68 in the direction of the workpiece.

In the present case, the powder discharge device 12 illustrated has a stepped offset 69 around the opening 15. This makes it possible to prevent the powder discharge element 60, or the small tube 62, slipping through in the direction of the workpiece.

In the present case, the length of the powder discharge element 60 is selected in such a way that a region 72 projects out of the powder-outlet opening 64. This exposed region 72 can make it easier to exchange the powder discharge element 60. For this, it is advantageous to not provide the above described offset 69, or to make the offset 69 as small as possible, with the result that it is not an obstacle or is an obstacle to the smallest possible extent when the powder discharge element 60 is being exchanged. To exchange the illustrated powder discharge element 60, it is possible, for example, to use tongs to grip the powder discharge element 60 in the exposed region 72 and pull it out of the powder discharge unit 14 through the powder-outlet opening 64. Such pulling out of the powder discharge element 60 is often easier, since dirt possibly clings to the powder discharge element 60 and makes it more difficult to push it inward through the powder discharge unit 14, in the direction of the inlet side 42.

The powder discharge device 12 shown in FIG. 11 has a bottom edge 70. In the exemplary embodiment illustrated, the edge 70 constitutes the deepest point of the powder discharge device 12. In the case of EHLA, the distance between the workpiece and this edge 70 is preferably 12.5 mm or more. At this small distance, a better shielding-gas covering can be ensured.

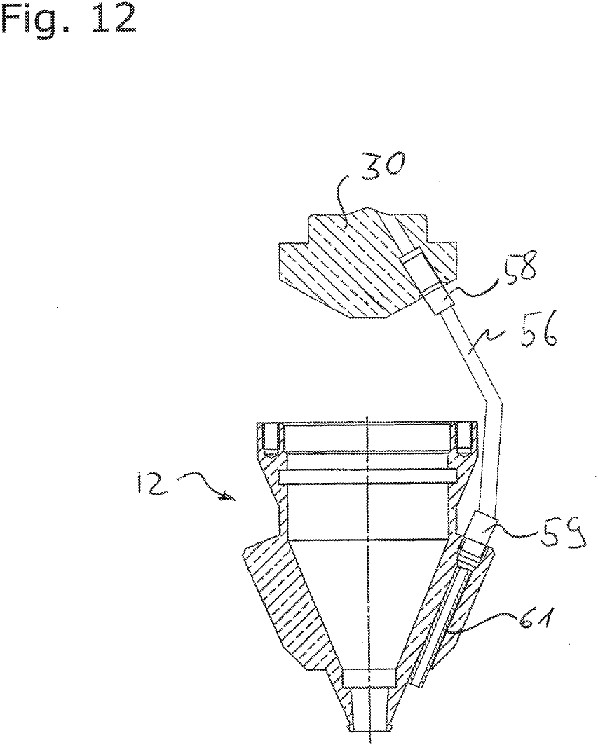

FIG. 12 shows a cross section, from the side, according to FIG. 10 with a further exemplary embodiment of a powder discharge element 61. The exemplary embodiment of the powder discharge element 61 differs from the powder discharge element 60 shown in FIG. 11 in that it has a larger inside diameter. It is possible to select or set a desired inside diameter by mutually exchanging the powder discharge elements 60 and 61.

The inside diameter of the powder discharge element 60 or 61 is decisive for the diameter of the powder stream flowing through the powder discharge element 60, 61. In this way, by varying the inside diameters of the powder discharge elements 60, 61, it is possible to set the diameter of the individual, in the present case seven, powder streams.

Varying the individual powder stream diameters makes it possible to vary the common powder focus diameter. If, for example, larger inside diameters of the powder discharge elements 60, 61 are selected, this results in larger powder diameters of the individual, in the present case seven, powder streams, which in turn results in a larger common powder focus diameter. Correspondingly, smaller inside diameters of the powder discharge elements 60, 61 result in a smaller common powder focus diameter.

Since the two mutually exchanged powder discharge elements 60, 61 must at least partially fit into the same powder discharge unit 14, the powder discharge elements 60, 61 preferably have the same outside diameter.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A material deposition unit, comprising:
a radiation unit designed to emit electromagnetic radiation in a directed manner onto a workpiece along a beam axis extending in a beam direction,
a powder discharge device having multiple powder discharge units configured to discharge powder in a directed form onto the workpiece through powder-outlet openings,
a powder division unit having multiple powder channels, a number of powder channels corresponding to a number of powder discharge units, the powder division unit being designed to distribute a central powder stream guided to a feed channel uniformly over the powder channels,
wherein each respective powder channel is connected to a respective powder discharge unit by an exchangeable connecting element, at least one powder discharge unit has an exchangeable powder discharge element, the powder discharge element being elongate, having a first end and a second end, and being arranged at least partially within the corresponding powder discharge unit.

2. The material deposition unit as claimed in claim 1, wherein at least one powder discharge unit is configured in such a way that a powder discharge element arranged at least partially in the powder discharge unit can be exchanged for another powder discharge element, the mutually exchangeable powder discharge elements having a different inside diameters and/or different lengths.

3. The material deposition unit as claimed in claim 1, wherein the second end of at least one powder discharge element is arranged in the region of the powder-outlet opening of the corresponding powder discharge unit.

4. The material deposition unit as claimed in claim 1, wherein the second end of at least one powder discharge element is arranged outside the corresponding powder discharge unit.

5. The material deposition unit as claimed in claim 1, wherein at least one connecting element is flexible.

6. The material deposition unit as claimed in claim 1, wherein the powder division unit has a longitudinal axis along which the feed channel extends, and the feed channel comprises:
a first functional zone that is elongate and has a first end, a second end and a round inside diameter, and
a second functional zone that is elongate and has a first end, a second end and a round inside diameter,
the second end of the first functional zone leading in line into the first end of the second functional zone.

7. The material deposition unit as claimed in claim 6, wherein the first functional zone is arranged in a first functional element and the second functional zone is arranged in a second functional element.

8. The material deposition unit as claimed in claim 6, wherein the powder division unit has a separating part, in which the powder channels are arranged, the powder channels leading into an elevated region on a top side of the separating part, the elevated region being received in a receiving region of the second functional zone, which has an opening width larger than a portion of the second functional zone and complements the elevated region.

9. The material deposition unit as claimed in claim 6, wherein the inside diameter of the first functional zone is constant at least in a portion that leads into the second end.

10. The material deposition unit as claimed in claim 6, wherein the second functional zone comprises a first portion and a second portion, the second portion having a larger inside diameter than the first portion.

11. The material deposition unit as claimed in claim 6, wherein an inside diameter of the first functional zone in a region of the second end of the first functional zone and the inside diameter of the second functional zone in a region of the first end of the second functional zone are the same.

12. The material deposition unit as claimed in claim 6, wherein the second end of the first functional zone leads into a first portion of the second functional zone.

13. The material deposition unit as claimed in claim 10, wherein the powder channels extend in a straight line and fan out from a side facing a second portion, with the result that each powder channel spans an angle Alpha with the longitudinal axis of the powder division unit.

14. The material deposition unit as claimed in claim 8, wherein inlet openings of the powder channels lead into the elevated region and are arranged around a frustoconical projection, the lateral surface of which slopes toward the inlet openings of the powder channels.

15. The material deposition unit as claimed in claim 1, wherein each powder channel has a widened portion for receiving the connecting elements.

16. The material deposition unit as claimed in claim 1, wherein the powder discharge units are in the form of channels in the powder discharge device and, on an inlet side, each has a widened portion in which the respective connecting elements are received.

17. The material deposition unit as claimed in claim 16, wherein at least one powder discharge element is arranged coaxially with the corresponding powder discharge unit.

18. The material deposition unit as claimed in claim 1, wherein the powder discharge device has a bottom edge, and wherein a distance between the bottom edge and the workpiece is at least 12.5 mm.

19. The material deposition unit as claimed in claim 2, wherein the mutually exchangeable powder discharge elements having a same outside diameter.
